(19) United States
(12) Patent Application Publication
(10) Pub. No.: US 2001/0054986 A1
(43) Pub. Date: Dec. 27, 2001

(54) PEN-BASED SPLIT COMPUTER DISPLAY

(76) Inventor: MICHAEL V. LEMAN, EAGLE, ID (US)

Correspondence Address: COE F MILES, TROP PRUNER HU & MILES PC, 8554 KATY FREEWAY, STE 100, HOUSTON, TX, 77024

(21) Appl. No.: 09/314,058

(22) Filed: May 18, 1999

(51) Int. Cl. G09G 5/00

(52) U.S. Cl. 345/1.1

(57) ABSTRACT

A split display for a laptop computer may include a first display that is hinged to a base unit and displays conventional computer output. A second display that accepts input from a pen device may be hinged to the first display. The first and second displays may be used concurrently to enable both conventional computer output and pen-based capabilities. Also, the first and second displays may be used together as a single large display, or the displays may be used individually. A split display system may allow the first display to be folded around its hinge to rest against the back of the first display, thereby forming a standard laptop display. Additionally, the first display may be folded down to rest on the base unit, forming a pen-based tablet with the second display.

### BACKGROUND

The invention relates generally to computer displays and, more particularly, to pen-based laptop computer displays.

Pen devices may be used to provide input to a computer by using the pen to touch certain areas on a computer display. Because pen devices are more portable than other input devices such as mice and trackballs, the focus of pen-based computing has been on personal digital assistants and other portable computing devices. However, pen-based computers provide not only the convenience of interacting with a pen device, but may also provide capabilities that many personal computer users desire such as handwriting recognition and digitizing technology. As pen devices become an integral part of computing, a need will arise for the integration of both standard computer displays and pen-based displays in a single computer system. Conventional laptop computers, however, do not generally provide for pen-based and traditional computer displays to be used concurrently. Thus, it would be beneficial to simultaneously provide both conventional display and pen-based display capabilities in a laptop computer system.

### SUMMARY

In one embodiment, the invention includes a computer system having a first display coupled to a base unit. A second display may be coupled to the first display. One of the displays may accept input from a pen-type input device, and the computer system may be adapted to use the first and second displays concurrently. In another embodiment, the invention includes a display module having a first display coupled to a second display. One of the displays may be adapted to accept input from a pen-type device. Additionally, the display module may be configured to use the first and second displays concurrently.

### BRIEF DESCRIPTION OF THE DRAWINGS

FIG. 1 shows a laptop computer system having a split display in accordance with one embodiment of the invention.

FIG. 2 shows the folding of a second display in accordance with one embodiment of the invention.

FIG. 3 shows the folding of a first display in accordance with one embodiment of the invention.

### DETAILED DESCRIPTION

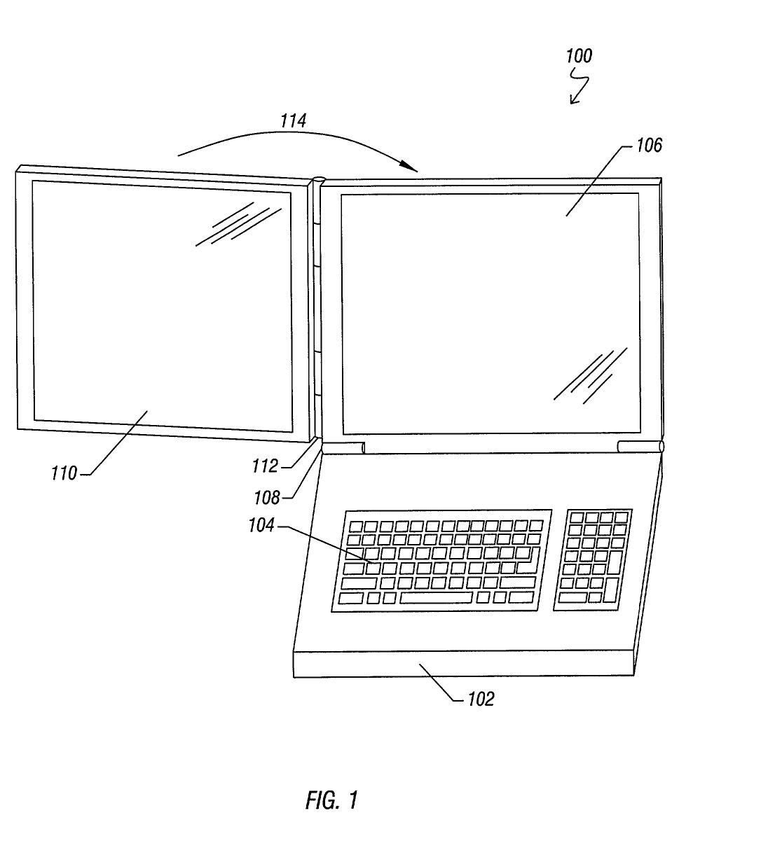

Referring to FIG. 1, an illustrative laptop computer system 100 in accordance with one embodiment of the invention may include a base unit 102 having a microprocessor, system memory, input and output controls, and a hard disk drive. A keyboard 104 may be located on the top of the base unit 102 to provide one source of input to the laptop computer system 100. The laptop computer system 100 may have a two-component display including a first display 106 and a second display 110. The first display 106 may be hinged to the base unit 102 by a hinge 108. The second display 110 may be hinged to either side of the first display 106 by a hinge 112. In another embodiment, the second display 110 may be hinged to the top of the first display 106. The first display 106 may be a liquid crystal display and provide conventional computer output such as raster images. For example, the first display 106 may be either an active or passive matrix display. The second display 110 may accept input from a pen device providing a pen-based computing environment. The pen-based display 110 may utilize any conventional pen device such as a light pen. The hinge 112 may be any standard type of hinge including a scissor hinge or friction hinge. Electrical conductors may be located within the hinge 112 to facilitate the transfer of input and output signals between the second display 110 and the base unit 102. Additionally, the electrical conductors within the hinge 112 may provide power to the second display 110.

A computer system in accordance with the invention may be operated in different modes depending upon the needs of a user. First, the laptop computer system 100 may be configured such that the first display 106 functions as a conventional display while the second display 110 functions as a pen-based display. In this configuration as illustrated in FIG. 1, the pen-based and conventional displays may be used concurrently. A user may provide input to the system 100 on the pen-based display 110 with a pen-type device while viewing conventional raster images on the first display 106. In another configuration of the laptop computer system 100, both components of the split display may be configured to form a single conventional output display that is much larger than standard laptop displays.

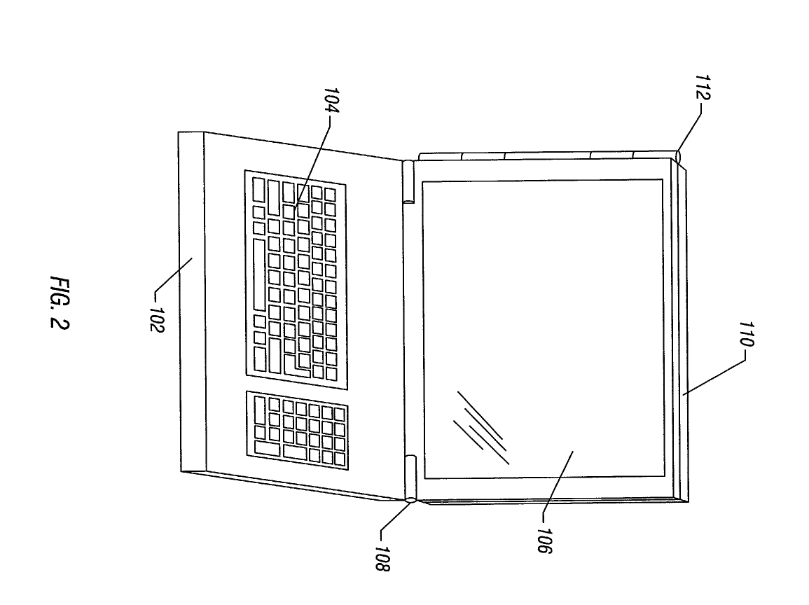

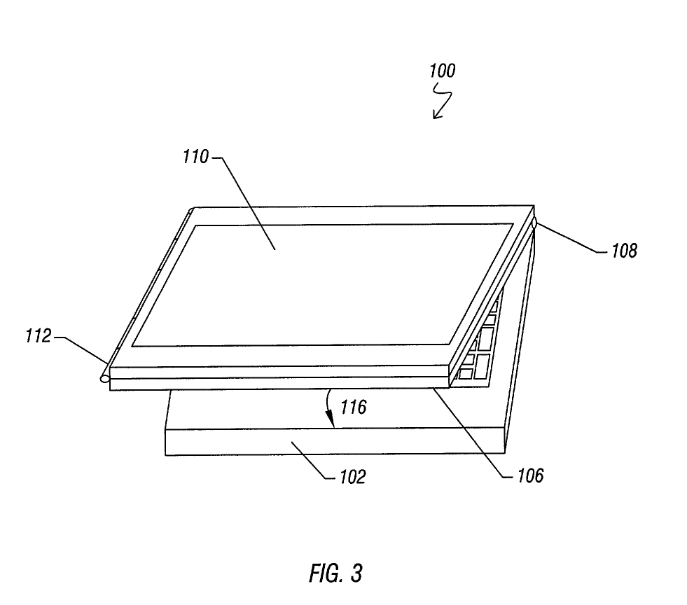

Additional configurations of the laptop computer system 100 may be available by folding the displays around their hinges. In one configuration, the first display 106 may function as a conventional computer display while the second display 110 may be folded back around its hinge 112 as shown by arrow 114. Referring to FIG. 2, for example, the second display 110 may be folded around completely such that the second display 110 rests against the back of the first display 106. This configuration allows a user to interact with the laptop computer system 100 as a conventional laptop with a standard output display. Referring to FIG. 3, yet another configuration of the laptop computer system 100 may be available by folding the first display 106 down around its hinge 108 as shown by arrow 116. The first display 106 may be folded down to rest on the surface of the keyboard 104, thereby forming a tablet with the second display 110. In this position, the second display 110 may be exposed and accept input from a pen-type device. A user may operate the laptop computer system 100 as a pen-based tablet.

By allowing various positions and configurations of the laptop computer system 100, the user gains several benefits over conventional laptop computers and pen-based tablets. One advantage of the invention is that the user is simultaneously provided with both conventional display capabilities and pen-based input capabilities from a split display as illustrated in FIG. 1. Moreover, the hinge mechanism between the first and second displays allows the use of both displays without adding components or detaching components from the laptop computer system 100. Another advantage of the invention is that the split display enables the use of displays that are much larger than those used in conventional pen-based tablets. Also, the use of hinges 108 and 112 allows a laptop in accordance with the invention to be folded into a compact configuration that is both convenient and portable.

While the invention has been disclosed with respect to a limited number of embodiments, numerous modifications and variations will be appreciated by those skilled in the art. It is intended, therefore, that the following claims cover all such modifications and variations that may fall within the true spirit and scope of the invention.

What is claimed is:

1. A computer system comprising:
a base unit;
a first display coupled to the base unit; and
a second display coupled to the first display, wherein one of the first and second displays is adapted to accept input from a pen-type input device, the computer system adapted to use the first and second displays concurrently.

2. The computer system of claim 1, wherein the first display is coupled to the base unit by a hinge.

3. The computer system of claim 1, wherein the second display is coupled to the first display by a hinge.

4. The computer system of claim 3, wherein the second display is coupled to a side of the first display by a hinge.

5. The computer system of claim 1, wherein the first and second displays may be positioned to form a pen-based tablet.

6. The computer system of claim 1, wherein the first and second displays may be configured to form a single large display.

7. The computer system of claim 1, wherein the first and second displays are liquid crystal displays.

8. A display module comprising:
a first display adapted to display raster images; and
a second display coupled to the first display, the second display adapted to accept input from a pen-type input device, wherein the first and second displays are adapted to be used concurrently.

9. The display module of claim 8, further comprising a base unit coupled to the first display.

10. The display module of claim 8, further comprising a base unit coupled to the second display.

11. The display module of claim 8, wherein the second display is coupled to the first display by a hinge.

12. The display module of claim 8, wherein the second display is coupled to a side of the first display by a hinge.

13. The display module of claim 8, wherein the first and second displays may be positioned to form a pen-based tablet.

14. The display module of claim 8, wherein the first and second displays may be configured to form a single large display.

15. The display module of claim 8, wherein the first and second displays are liquid crystal displays.

16. A method to use a computer system having a raster image display element and a pen-based display element comprising:
arranging the computer system such that the raster image display element and the pen-based display element are viewable by a user; and
operating the computer system by interacting with the raster image display element and the pen-based display element concurrently.

17. The method of claim 16, wherein the raster image display element and the pen-based display element may be positioned to form a pen-based tablet.

18. The method of claim 16, wherein the raster image display element is coupled to the pen-based display element by a hinge.

19. The method of claim 16, wherein the raster image display element and the pen-based display element may be configured to form a single large display element.

20. The method of claim 16, wherein the raster image display element comprises a liquid crystal display element.
